(19) United States
(12) Patent Application Publication
(10) Pub. No.: US 2026/0227632 A1
(43) Pub. Date: Aug. 6, 2026

(54) A METHOD FOR ADJUSTING LIGHT THROUGH A SMART LENS

(71) Applicant: Telefonaktiebolaget LM Ericsson (publ), Stockholm (SE)

(72) Inventors: Alexander HUNT, Limhamn (SE); Tommy ARNGREN, Södra Sunderbyn (SE)

(73) Assignee: Telefonaktiebolaget LM Ericsson (publ), Stockholm (SE)

(21) Appl. No.: 19/151,375

(22) PCT Filed: Jan. 30, 2023
(86) PCT No.: PCT/EP2023/052124

§ 371 Date: Jul. 28, 2025

(51) Int. Cl. G02B 27/01; G02C 7/04; G02C 7/08; G02C 11/00; G09G 3/34

(52) U.S. Cl. CPC G02B 27/0172; G02C 7/04; G02C 7/086; G02C 11/10; G09G 3/34; G02B 2027/0138; G02B 2027/014; G02B 2027/0147; G09G 2320/0613; G09G 2320/0626

(57) ABSTRACT

A method in a smart lens (400) for controlling an active area of a display (505) of the smart lens (400) is suggested where the pupil size of a user is determined, using the smart lens (400) and where the size of an active area of a display (505) of the smart lens (400) is determined, based on content of an acquired user interface, UI, image and the determined pupil size, so that a total illuminance exposed to the retina of the user can be controlled, based on determined ambient illuminance and illuminance of the active area of the display (505), so that the size of the active area of the display (505) is maintained substantially constant for a series of consecutive user interface, UI, images, irrespective of the content of the user interface, UI, image.

### TECHNICAL FIELD

Disclosed are embodiments related to a smart lens for controlling an active area of a display of the smart lens and a smart lens, configured to be able to execute the suggested method.

### BACKGROUND

Displays in augmented reality systems are evolving fast. Research has been done in the fields of adding electronics on a contact lens, and lens electronics have been used for multiple applications, such as e.g., for dynamic vision correction and for displaying images. Electro-active vision correction has been proposed as means of adjusting lens correction, depending on different conditions, such as e.g., distance from objects being viewed, ambient light or size of the pupil.

The pupil size varies depending on the light conditions. In dim light, the pupil will typically expand, to allow more light to enter the eye, whereas in bright light, the pupil instead contracts. A pupil can in this way range in diameter from 1.5 mm to more than 8 mm, depending on the light exposed to the eye.

US2016299354 refers to a smart contact lens system which has integrated a number of electronic, optoelectronic or optical components on a contact lens substrate for the purpose of identifying and tracking changes in pupillary response, due to mental task engagement.

US2009189830 discloses a display device, mounted on and/or inside the eye, where the display contains multiple sub-displays, each of which project light to different retinal positions within a portion of the retina, corresponding to the sub-display.

### SUMMARY

An objective of embodiments disclosed herein is to solve or at least alleviate at least one of the above-mentioned problems.

According to one aspect, a method in a smart lens for controlling an active area of a display of the smart lens is suggested, where the method comprise: determining the pupil size of a user, using the smart lens; adapting the size of an active area of a display of the smart lens, based on content of an acquired UI image and the determined pupil size, and controlling a total illuminance exposed to the retina of the user, based on determined ambient illuminance and illuminance of the active area of the display, so that the size of the active area of the display is maintained substantially constant for a series of consecutive UI images, irrespective of the content of the UI image.

According to another aspect, a smart lens system for controlling an active area of a display of a smart lens is suggested, where the display comprises a matrix of display elements, processing circuitry and a memory, storing instructions that when executed by the smart lens system, causes the smart lens system to: determine the pupil size of a user, using the smart lens; acquire a UI image; adapt the size of an active area of the display of the smart lens, based on content of the UI image and the determined pupil size, and control a total illuminance exposed to the retina of the user, based on determined ambient illuminance and illuminance of the active area of the display, so that the size of the active area of the display is maintained substantially constant for a series of consecutive UI images, irrespective of the content of the UI image.

According to yet another aspect, a smart lens system for controlling an active area of a display of a smart lens, where the display comprises a matrix of display elements, the smart lens system can be described as comprising a plurality of, mutually interconnected, functional units, sensors, a display and a dimming layer, configured to provide smart lens functionality as described herein. More specifically such a configuration may be configured as comprising a determining unit for determining the pupil size of a user, using the smart lens; an acquiring unit for acquiring a UI image; an adapting unit for adapting the size of an active area of the display of the smart lens, based on content of the UI image and the determined pupil size, and a controlling unit for controlling a total illuminance exposed to the retina of the user, based on determined ambient illuminance and illuminance of the active area of the display, so that the size of the active area of the display is maintained substantially constant for a series of consecutive UI images, irrespective of the content of the UI image.

### BRIEF DESCRIPTION OF THE DRAWINGS

The accompanying drawings, which are incorporated herein and form part of the specification, illustrate various embodiments.

FIG. 1 illustrates a flow chart of a method executable in a smart lens.

FIG. 2 illustrates another flow chart highlighting parts of the method according to FIG. 1.

FIG. 3 illustrates yet another flow chart highlighting other parts of the method according to FIG. 1.

FIG. 4 illustrates a cross section of a smart lens, according to one embodiment.

FIG. 5 illustrates a smart lens as seen from the front, according to one embodiment.

FIG. 6 is a block scheme of smart lens system, according to one embodiment.

FIG. 7 is another block scheme of a smart lens system, according to another embodiment.

FIG. 8 is yet another block scheme of a smart lens system, according to yet another embodiment.

### DETAILED DESCRIPTION

The pupil of an eye reacts by dilating, i.e., taking different sizes, depending on different aspects, such as e.g. differences in illumination, the users state of mind or the distance to an observed object. The pupil size does not directly affect the field of vision, but it does affect the perceived depth-of-field, such that objects will appear blurrier in the edges of the vision in situations where the pupil size is small. Things are, however, different for objects displayed very close to the eyes, e.g., in a smart lens display. If the pupil size is smaller than the display size, then light from the edges of the display will not be perceived by the user, meaning that a display on a smart lens could be a small part of the pupil at one scenario and too large in another. To counteract this, display size could be dynamically adjusted according to the size of the pupil.

Another aspect is that the ambient light intensity will also affect the pupil size. Going from a darker environment to a brighter environment will make the pupil smaller as a higher light intensity will hit the retina, in the latter situation. Naturally, the opposite will happen if a person goes from a bright environment to a dark environment. Today's solutions of smart lenses do not provide means to manage changes of pupil size, due to changes in ambient light and/or changes in content displayed on smart lenses.

The mentioned problem with changing ambient light and changing content on a lens display will affect the pupil size. A purpose with a method as disclosed herein is therefore to keep the pupil size constant, or at least as constant as possible, to be able to show the full or a specific, decided size of the active pixels on the lens, irrespective of changes in the amount of light in the environment of the smart lens. By reducing the required fluctuation of the active display size and thereby also the pupil size, it will be less tiresome for the brain and eyes to watch content being presented on the smart lens. To be able to achieve this we want to assure that we keep a substantially constant light intensity that is entering the eye and thus hitting the retina, irrespective of if there is anything to show on the display or not, so that the brain does not need to decide to change the pupil size, or can at least minimize the change, based on the light hitting the retina.

In order to solve the posed problem the size of a smart display is first determined. One method for determining the size of a smart lens is e.g. known from EP3948404A1, which disclose a method for determining the size of the pupil, as well as the number of active pixels needed to fill the display of a smart lens to its maximum size. Furthermore, it is known to apply one or more light sensors for each eye, each of which are facing away from the eye, for determining the ambient light intensity of the smart lens.

With the size of the smart lens display known and the number of pixels that are lit with a certain luminance, together with information from the light sensors of a smart lens, measuring the surrounding, ambient light intensity, the total light intensity that is entering the eye can be calculated by sensors arranged in at least one layer of the smart lens. Such at least one layer typically also comprises pixels, providing the display functionality of the smart lens.

To be able to keep the light intensity at a substantially constant level, another lens layer, herein referred to as a dimming layer, that is capable of adapting the light intensity by dimming the ambient light, is also suggested.

A further possible aspect is to arrange a smart lens system, comprising a host system, from hereinafter referred to as a host, which may be arranged remote from the smart lens, such as e.g. in a smartphone, smartwatch or any other device which is able to connect to, and interact with the mentioned layers of the smart lens, thereby providing lens control, possibly in combination with a driver functionality. Alternatively, the host may be integrated into the smart lens. In the latter situation, the host is arranged outside the area of the pupil, when the smart lens is placed on the eye. A further aspect of the control mechanism in a host system may include capabilities to predict changes in light from content and ambient light. Such a feature may apply any type of known prediction method.

More specifically, by determining the pupil size of a user of a smart lens, and by adapting the size of an active area of a display of the smart lens, worn by the user, based on content of a User Interface (UI) image, acquired for display on the display, and the pupil size, it will be possible to control a total illuminance exposed to the retina of the user, based on a determined sum of the ambient illuminance and the illuminance of the active area of the display, so that the size of the active area of the display is maintained substantially constant for a series of consecutive UI images, irrespective of the content of the UI image. The suggested smart lens is configured as a layered smart lens, which comprise various layers, capable of carrying a lens display, sensors and a dimming layer, where the dimming layer is capable of controlling ambient light intensity of the lens.

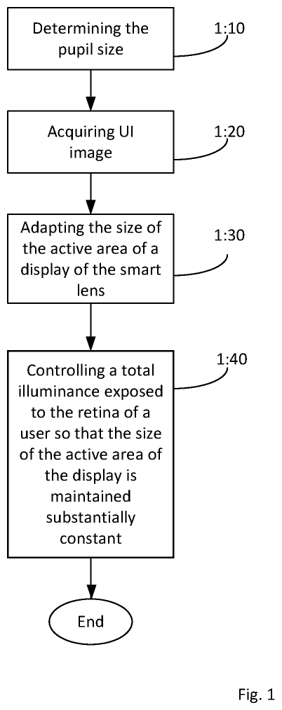

A method executable in a smart lens will now be described in further detail with reference to FIG. 1, where the size of the pupil of a user, wearing the smart lens, is determined, as indicated with step 1:10, using at least one sensor, capable of pupil size measurement, and, as indicated with another step 1:20, a UI image is acquired, followed by executing steps necessary for presenting the UI image to the user of the smart lens on a display, arranged on the smart lens. The pupil size can be determined by measuring illuminance, captured by one or more sensors, distributed over the lens, so that the one or more sensors is/are facing the pupil of the user of the smart lens. According to one embodiment, one or more light sensors, each comprising at least two sensor elements, wherein the pupil size can be determined by measuring the illuminance at the pupil, are used, using one of the sensor elements, whereas the illuminance at the iris can be measured using another of the sensor elements.

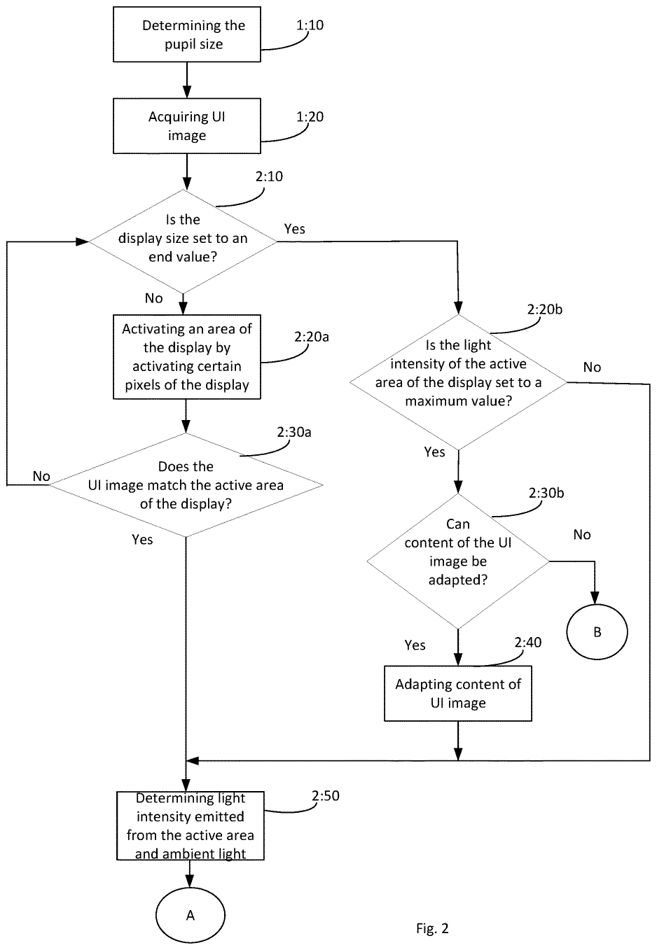

Based on content of the acquired UI image and the determined pupil size, the size of an active area of the display of the smart lens is, according to step 1:30 adapted, so that the display can be used in an efficient way, when kept at a substantially constant size, i.e., with a substantially constant diameter. Such an adaptation can be executed by activating a certain number of the pixels, according to step 2:20a of FIG. 2. Typically, pixels close to the boundary of the pupil are activated. According to step 1:40 of FIG. 1, a total illuminance, exposed to the retina of the user, is then controlled, so that the adapted size of the active area of the display is maintained substantially constant. The active area of the display can be maintained substantially constant for a series of consecutive UI images by maintaining certain pixels of an active area of the display active for the series of consecutive UI images. Alternatively, steps 1:10 and 1:20 may be executed in the reverse order, so that the pupil size is determined, before a UI image is acquired.

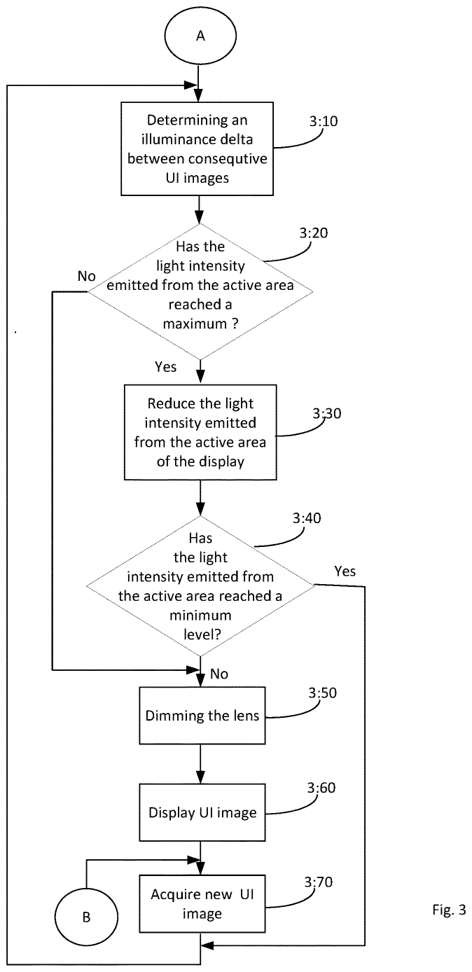

A more detailed approach on the adapting according to step 1:30 of FIG. 1 will now be presented with reference to FIG. 2, where after steps 1:10 and 1:20 (executed in any order) of FIG. 1 have been executed it is determined whether the display of the smart lens has been set to an end value, i.e. if the chosen display size is set to its minimum or maximum display size or not, as indicated with step 2:10. If it is determined that the display size is not, at this stage, set to an end value, which of course would be a preferred scenario for being able to perform the suggested method in an optimized way, a previously adapted area of the display is activated, by activating certain pixels of the display, as indicated with step 2:20a. Step 2:20a will be described in further detail below, with reference to FIG. 3.

Following the activation of the display area, according to step 2:20a, it is determined whether or not the UI image match the active area of the display, i.e. if the UI image fit and can be presented on the adapted display area, as indicated with step 2:30a. If this is the case, the sum of the light intensity, emitted from the active area of the display and the intensity of the ambient light is determined, as indicated with step 2:50, whereas if instead this is not the case, the method proceeds instead to step 2:10. After step 2:50 has been executed, the method continues as illustrated with A in FIGS. 2 and 3.

If it is instead determined in step 2:10 that the display size is set to an end value, it is, as a next step 2:20b, determined if the light intensity of the active area of the display is set to a maximum value, i.e. if also the light intensity of the active area is set to an end value. If determined that the mentioned light intensity is set to a maximum value, it is then determined, in another step 2:30b, if the content of the UI image can be adapted, i.e. if there is still room for adaptation of the content of the UI image, even though the intensity of the active area cannot be increased any more, due to that it has reached its maximum value. If it is determined that the light intensity of the active area of the display is set to a maximum value and if it is also considered that adaptation of the content of the UI image is possible, suitable adaptations of the content of the UI image, such as e.g. adaptation of the contrast or light intensity of the pixels of the smart lens, are executed at this stage, according to step 2:40, before the method continues at step 2:50.

A UI image adaptation may comprise removing content from the UI image, by removing at least one specific object from the UI image, by removing at least one part of the UI image or a combination of both. Removing a specific object of a UI image may e.g. mean that a specific symbol, or even all symbols, belonging to a certain category of symbols, which are considered to have lower priority at the moment, can be omitted from the UI image. Alternatively, or in addition, the contrast between pixels of the UI image may be increased, as another means of UI image adaptation. If, however, it is considered that content of the UI image cannot be adapted, the method instead continues according to the flow chart of FIG. 3, as illustrated with B in FIGS. 2. and 3.

Looking now in detail at the continuation of the method, as described above, with reference to FIG. 3, the method when continuing at A determines a difference between two consecutive UI images, i.e. the difference between the illuminance of the a presently shown and previously shown UI image, from hereinafter referred to as an illuminance delta, as indicated with step 3:10. Next it is determined if the light intensity, emitted from the active area of the display, has reached a maximum level, as indicated with step 3:20. If a maximum level is considered to have been reached, the light intensity, emitted from the active area of the display, is reduced, based on the determined delta, as indicated with step 3:30, followed by determining if the light intensity, emitted from the active area of the display has instead reached a minimum level, as indicated with step 3:40, whereas steps 3:30 and 3:40 are bypassed in case a maximum has not been reached in step 3:20.

Following step 3:40 or the bypass, as suggested above, dimming of the smart lens is then executed, as indicated with step 3:50. Dimming can be based on a determined change of the illuminance of the active area of the display between two consecutively acquired UI images. More specifically the mentioned change may be defined as a determined change of the ambient illuminance and the illuminance of the active area of the display between two consecutively acquired UI images, as determined in step 3:10. The dimming is typically executed at a certain layer of the smart lens, herein referred to as a dimming layer. The dimming may, according to one embodiment, be executed based on content of a look up table (LUT), wherein the LUT comprise a dependency between ambient light intensity and total light intensity, which is used for blocking the same amount of light that is produced by the active area of the display. The mentioned LUT approach can be considered as a course approach, whereas according to an alternative approach, the light intensity emitted from the active area of the display can instead be determined by the smart lens. If, during dimming, the dimming is set to a maximum, the light intensity of the display may be lowered a bit in order to accommodate a change in ambient light intensity, whereas if a minimum level is reached, the display size may instead be adjusted to lower the number of active pixels of the display.

As indicated with another step 3:60, dimming of the smart lens is followed by displaying the acquired UI image on the display of the adapted smart lens, after which a new UI image is acquired, as indicated with another step 3:70, before the process according to FIG. 3 is again repeated, starting from step 3:10, where the new acquired UI image is compared to the previously acquired UI image. If instead a minimum level is found to have been reached in step 3:40, steps 3:50-3:70 are all bypassed, after which the process is continued from step 3:10.

If starting at B, following execution of steps of FIG. 2, a new UI image is initially acquired, according to step 3:70, before the process of FIG. 3 is executed, continuing from step 3:10. By iteratively repeating the mentioned process, the dimming may sequentially strive for keeping the display size substantially constant, thereby also resulting in that the iris of the user, as well as the active area of the display, are maintained substantially constant.

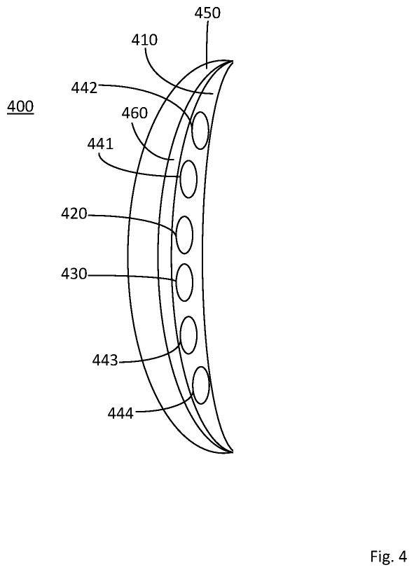

As already mentioned, the smart lens suggested herein will comprise a plurality of layers, each having different purposes. FIG. 4 is illustrating a smart lens 400, comprising at least three layers, according to one embodiment. Next to the eye, the smart lens 400 comprise a layer, being arranged as a substrate layer, here referred to as a pixel/sensor layer 410, comprising pixels, forming a display of the smart lens, and two or more sensors, here represented by the two sensors 420, 430, which are typically photosensors.

At least one of these sensors 420 containing at least two active sensor elements is facing towards the eye, calculating the pupil opening size, whereas at least one of the other sensors 430 is facing in the opposite direction, and being configured to determine the ambient light intensity, configured to determine the amount of light that hits the retina of a user of the smart lens 400, as described above. If the pixel/sensor layer 410 is tissue friendly, i.e., made of a material which allows the pixel/sensor layer 410 to be in direct contact with the eye, this layer will be the final inner layer of the smart lens. If, on the other hand, the pixel/sensor layer cannot be considered to be tissue friendly, the inner part of the pixel/sensor layer, facing the eye, may be covered by a tissue friendly layer (not shown). A suitable technology for such a tissue friendly substrate is LTPS (Low-Temperature Poly-Silicon), Oxide TFT (Thin Film Transistor) or amorph-silicon.

The pixel/sensor layer 410 is also used for carrying pixels, here represented by pixels 441, 442, 443, 444, capable of providing display functionality, enabling visual content to be presented to a user of the lens. Alternatively, the pixels and sensors may be arranged in separate layers of the smart lens 400. The pixels 441, 442, 443, 444 are faced so that when they are active they will emit light towards the eye.

The smart lens also comprises a further layer 450, here referred to as a dimming layer, which may have two functions. The first function is to act as a protective layer for the sensors and pixels of the first layer, whereas the second purpose is to act as a dimming or blocking layer, which is arranged as an optoelectrical part (not shown) of the lens which controls the amount of ambient light that can pass through the lens. The dimming layer 450 can be configured as comprising a single pixel, controlling the full surface of the layer and the display that need to be dimmable, or it can be divided into several segments, each being either equal in size and form or different in size and form. A dimming layer 450, comprising more than one segment, may be configured so that different segments can-be individually controllable to be able to dim or block light differently from different ambient light directions. In case the dimming layer 450 consists of multiple segments, each segment can be provided with a separate sensor to be able to measure the ambient light hitting that part of the smart lens.

Different technologies can be used for arranging the dimming layer 450, such as e.g. LCD (Liquid Crystal Display) or a similar technology. Some other technologies that alternatively can be considered are electrochromic materials, polymer dispersed liquid crystal, suspended particles, micro-blinds or nano-blinds. Alternatively, unless the dimming layer 450 is capable of operating also as a protective layer towards the pixels and sensors, yet another, optional layer 460 can be arranged between the pixel/sensor layer and the dimming layer, operating as a protective layer. Such a layer may be e.g., a plastic or a glass layer, or a layer with similar physical properties. Finally, the smart lens 400 may have an outer layer (not shown), providing physical protection to the smart lens 400, and the dimming layer 450. The mentioned display, comprising the mentioned pixels, may be configured as a segmented display or a full matrix display of display elements, which typically is an emissive type of technology, such as e.g. OLED (Organic Light Emitted Diode) or micro-LED (Light Emitted Diode).

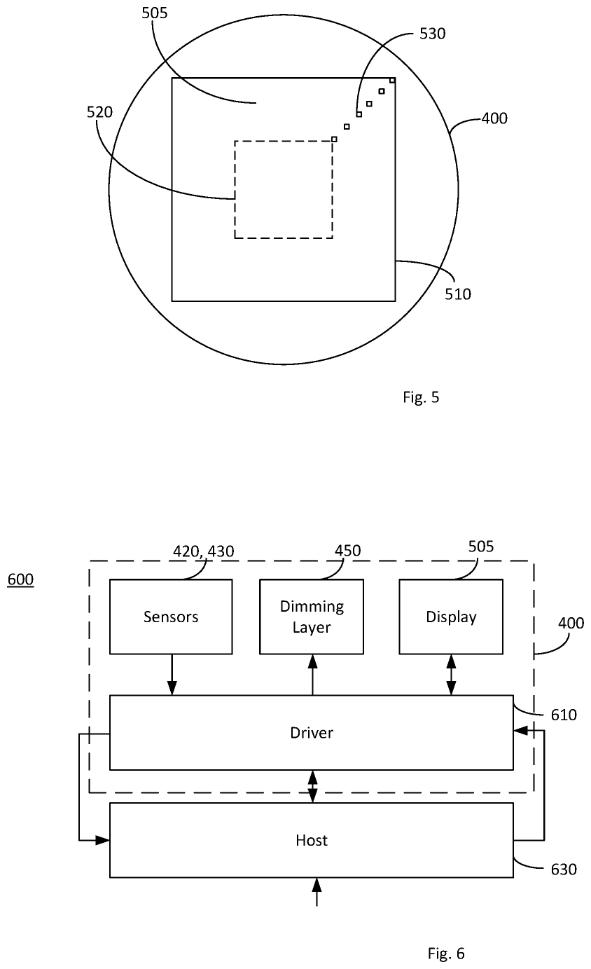

A display according to one embodiment is illustrated in FIG. 5, where a smart lens 400, comprises an active area, illustrated with area 510 which in the present example is close to the maximum area of a square formed display 505 of the smart lens 400, and which has a minimum area, indicated with 520. Content to be presented on the display 505 may either be passed directly to the display 505, or provided to the display 505 from a storage, accessible to the smart lens 400. The size of the display 505 will be controllable, by way of controlling which pixels 530 of the display 505 that are to be active by determining the number of pixels 530 that are supposed to form the display, based on the input from the one or more sensors (not shown), such as e.g. one or more photodiodes, facing the eye. In FIG. 5 active sensors/photodiodes are represented by array 530, here comprising six photodiodes. It is to be understood that in a typical scenario, photodiodes may be activated more evenly distributed, surrounding the active area of the display.

A smart lens 400 may, according to one embodiment, be configured as forming part of smart lens system 600, comprising or constituting a smart lens 400, configured to be controllable, as suggested herein, according to one embodiment, as suggested below with reference to FIG. 6. The smart lens 400 of the smart lens system 600 comprise a display 505, comprising a dimming layer 450 and sensors 420, 530, as described herein. According to FIG. 6, the smart lens system 600 also comprise a driver 610, here forming part of the smart lens 400, and a host 630, connected to the smart lens 400. The host 630 is configured as a processing unit or circuitry which is configured to control a driver 610 of the smart lens 400, and to provide data to the display 505, via the driver 610. The host 630 may typically also be configured to control the dimming layer 450, whenever required. In addition, further devices and/or sensors which may me connected to the smart lens system 600, may typically be connected via the host 630. The host 630 may be arranged remotely from the smart lens 400, as indicated in FIG. 6, such as e.g. by forming part of a smartphone, smartwatch or any other device which is able to connect to, and interact with the mentioned smart lens 400. Alternatively, the host may be integrated into the smart lens. In the latter situation, the host 630 is typically arranged outside the area of the pupil, when the smart lens 400 is placed on an eye. A further aspect of the control mechanism of the host 630 may include capabilities to predict changes in light from content and ambient light. Such a feature may be based on any type of known prediction mechanism.

The driver 610 is another hardware component or processing circuitry, configured to handle components connected to it, when being controlled by the host 630. The driver 610 typically has limited compute power, since it is typically only performing limited calculations. The driver 610 may comprise, or be connected to, memory for register control and possibly also a Graphic Random-Access Memory (GRAM) for storing display information to be presented on the display of the smart lens 400. If a LUT is applied by the smart lens 400 also the LUT may be arranged on the driver 610.

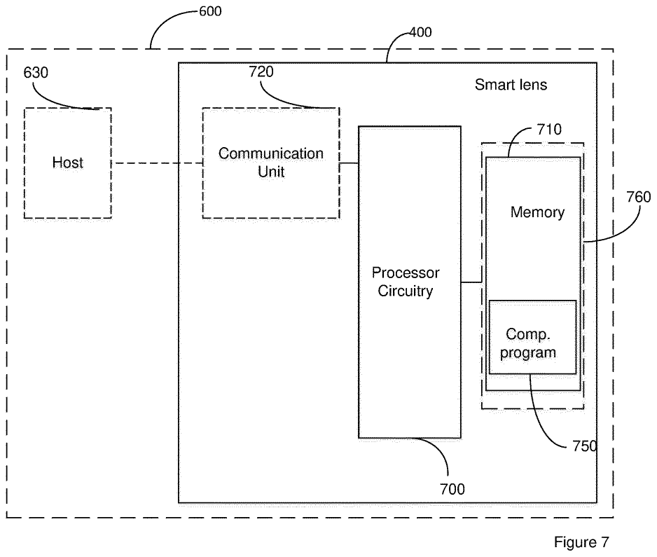

A smart lens 400 according to another embodiment will now be described in further detail according to FIG. 7. The smart lens 400 of FIG. 7 comprise processor circuitry 700 and a memory 710, storing computer readable instructions, which when executed by the smart lens 400, is configured to cause the smart lens 400 to execute a method according to any of the embodiments disclosed herein. In case all functionality needed for executing a method according to at least one of the mentioned methods is arranged at the smart lens 400, the mentioned smart lens can be seen as comprising a complete smart lens system. Alternatively, a smart lens system may be divided into the smart lens 400 and at least one more physical entity, e.g. according to the embodiment, illustrated in FIG. 6, or similar, where communication between the smart lens 400 and the at least one other physical entity, here a host 630, can be executed via a communication unit 720.

More specifically, the smart lens 400 can, according to one embodiment, be caused to determine the pupil size of a user, using the smart lens 400, and to acquire a UI image, after which the size of an active area of a display of the smart lens is adapted, based on content of the UI image and the determined pupil size, The smart lens 400 can also be caused to control a total illuminance exposed to the retina of the user, based on determined ambient illuminance and illuminance of the active area of the display, so that the size of the active area of the display is maintained substantially constant for a series of consecutive UI images, irrespective of the content of the UI image.

According to one embodiment, the smart lens 400 can be caused to determine the pupil size by measuring illuminance, captured by at least one sensor 420, 430 containing at least two active sensor elements, facing the pupil of the user of the smart lens, and being configured to execute such measuring. Such sensors may be arranged in one layer of the smart lens 400, which, if this layer is also carrying pixels, constituting the display area of the smart lens 400, may be referred to as a pixel/sensor layer. Alternatively, pixels and sensors may be arranged in separate layers.

According to one embodiment, the smart lens 400 can be caused to adapt the size of the active area of the display by activating a certain number of the pixels, distributed over the area of the smart lens 400.

The size of an active area of the display can be maintained substantially constant for a series of consecutive UI images by maintaining, by the smart lens 400, a certain number of pixels of the active area of the display, active for a series of consecutive UI images.

The smart lens 400 can be caused to adapt the content of the most recently acquired Ul image, in case it is determined, by the smart lens 400, that the light intensity of the active area of the display 505 has reached a value, which has been defined as a maximum value of the smart lens 400.

When adapting the most recently acquired UI image, the smart lens 400 may be caused to adapt according to one or more different criteria, such as e.g. by removing content from the UI image by removing at least one specific object from the UI image, Such an object may e.g. be a type of object that is considered to be of limited or no relevance at a certain occasion or scenario. Alternatively, at least one specific part of the UI image, considered to be less relevant, may be removed. According to yet another embodiment the smart lens 400 may be configured to execute adaptations by adapting the contrast between pixels of a UI image.

According to one embodiment, the smart lens 400, may be configured to control the total illuminance of the smart lens by dimming the lens, based on a determined change of the illuminance of the active area of the display 505 between two consecutively acquired UI images. Thereby the amount of light, allowed to pass through the smart lens 400 is controlled by directly controlling the transparency of the smart lens 400.

More specifically, according to one embodiment the smart lens 400 can be caused to determine the pupil size of the user by measuring the illuminance at the pupil, using one sensor element and measuring the illuminance at the iris, using another of the sensor element. Typically, pixels 530 arranged in an area of the smart lens 400, distributed substantially close to the boundary of the pupil may be activated, whereas pixels 530, located outside this boundary may instead be deactivated

When adapting the most recently acquired UI image, the smart lens 400 may be caused to adapt according to one or more different criteria, such as e.g. by removing content from the UI image by removing at least one specific object from the UI image, Such an object may e.g. be a type of object that is considered to be of limited or no relevance at a certain occasion or scenario. Alternatively, at least one specific part of the UI image, considered to be less relevant, may be removed. According to yet another embodiment the smart lens 400 may be configured to execute adaptations by adapting the contrast between pixels of a UI image.

According to one embodiment, the smart lens 400, may be configured to control the total illuminance of the smart lens 400 by dimming the lens 400, based on a determined change of the illuminance of the active area of the display 505 between two consecutively acquired UI images. Thereby the amount of light, allowed to pass through the smart lens 400 is controlled by directly controlling the transparency of the smart lens 400. More specifically, such controlling can be executed by dimming the smart lens 400, based on a determined change of the ambient illuminance and the illuminance of the active area of the display 505 between two consecutively acquired UI images. The dimming is typically executed by activating dimming of a layer, different from the layer comprising pixels and/or sensors. Furthermore, the dimming may be based on content least one look-up table of a LUT, available to the smart lens, i.e. by acquiring and applying predefined relations between available parameters. Alternatively, or in combination, the smart lens 400 may base the dimming on a determined light intensity emitted from the active area of the display of the smart lens 400.

For the purpose of determining the ambient illuminance, the smart lens 400 can, according to one embodiment, be caused to measure the illuminance with at least one light sensor of the smart lens 400, where such one or more light sensor is arranged faced away from the pupil of the user of the smart lens 400.

In case it is found, by the smart lens 400, that the dimming capacity of the smart lens 400 has reached its maximum level, the smart lens 400 may, according to one embodiment, be caused to reduce the light intensity emitted from the active area of the display 505.

The smart lens 400 may alternatively be arranged as a smart lens system 400′ comprising a driver 610 functionality, constituting hardware which is capable of controlling sensors, here represented by photosensors 530, pixels of a display 620 of the smart lens 400 and dimming layer 460 of the smart lens 400. The driver 610 of the smart lens system 400 is also connectable to a host 630, which may provide the driver 610 with data, such as e.g. predictions of upcoming light conditions, i.e. predictions on how one or more of the ambient light and the light exposing the display are predicted to progress. The driver 610 can be configured to run on limited computer power, which is sufficient for performing limited calculations, capable of providing the basic functionality of the smart lens system 400, and can therefore be arranged at the smart lens 400 itself, or separated from the smart lens 400. The driver 610 typically comprise a memory capability for storing register control and possibly also GRAM (Graphic Random-Access Memory) or other type of memory for storing display information. The driver may also comprise one or more LUTs, or, alternatively, be accessible to one or more LUTs.

The host 630 is a processing unit, capable of controlling the driver 610, providing data to the display 620 functionalities, and may also be the entity controlling the dimming layer 460 and/or changing the content of the display. The host 620 may also be connected to other sensors (not shown). The host 620 may form part of the smart lens 400 or, more typically, be configured to form part of a separate device, such as e.g. a smartphone, smartwatch, smart glasses or wearable, connectable to the smart lens 400. Alternatively, a part of or the host 420 may be operative in the cloud.

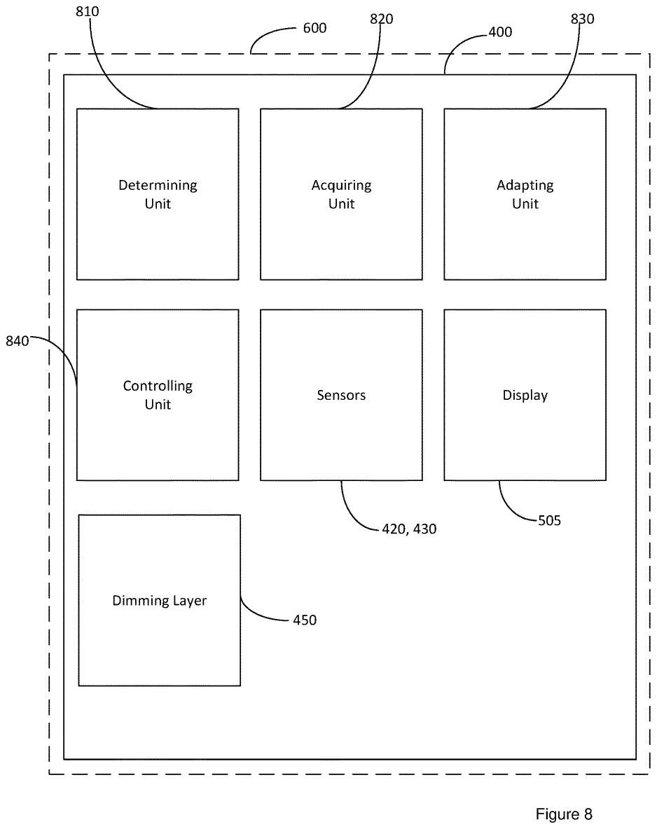

A smart lens system 400,600, capable to operate as described herein, may, alternatively be described as a smart lens system 400 600, according to FIG. 8, where the smart lens 400 comprise a display 505, comprising a matrix of display elements, which further comprise a determining unit 810 for determining the pupil size of a user, using the smart lens 400, an acquiring unit 820 for acquiring a UI image; an adapting unit 830 for adapting the size of an active area of the display 505 of the smart lens 400, based on content of the UI image and the determined pupil size, and a controlling unit (840) for controlling a total illuminance exposed to the retina of the user, based on determined ambient illuminance and illuminance of the active area of the display (505), so that the size of the active area of the display (505) is maintained substantially constant for a series of consecutive UI images, irrespective of the content of the UI image. Such a smart lens system 400, 600 also comprise sensors 420, 430, capable of sensing illuminance, and a dimming layer 450, capable of dimming parts of the smart lens 400, as described herein,

The aspects of the present disclosure have mainly been described above with reference to a few embodiments. However, as is readily appreciated by a person skilled in the art, other embodiments than the ones disclosed above are equally possible within the scope of the invention, as defined by the appended patent claims. Thus, while various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. A method in a smart lens for controlling an active area of a display of the smart lens, the method comprising:
determining the pupil size of a user using the smart lens;
adapting the size of an active area of a display of the smart lens based on content of an acquired user interface (UI) image and the determined pupil size, and
controlling a total illuminance exposed to the retina of the user based on determined ambient illuminance and illuminance of the active area of the display so that the size of the active area of the display is maintained substantially constant for a series of consecutive UI images, irrespective of the content of the UI image.

2. The method of claim 1, wherein determining the pupil size comprises measuring illuminance, captured by at least one light sensor, facing the pupil of the user of the smart lens.

3. The method of claim 2, wherein
the at least one light sensor comprises a first sensor element and a second sensor element, and
determining the pupil size of the user comprises measuring the illuminance at the pupil using the first sensor element and measuring the illuminance at the iris using the second sensor element.

4. The method of claim 1, wherein the size of the active area of the display is adapted by activating a certain number of pixels, distributed over the smart lens.

5-13. (canceled)

14. A smart lens system for controlling an active area of a display of a smart lens, the display comprising a matrix of display elements, the smart lens system comprising:
a memory storing instructions; and
processing circuitry operable to execute the instructions, wherein the smart lens system is configured to:
determine the pupil size of a user using the smart lens;
acquire a user interface (UI) image;
adapt the size of an active area of the display of the smart lens based on content of the UI image and the determined pupil size, and
control a total illuminance exposed to the retina of the user based on determined ambient illuminance and illuminance of the active area of the display so that the size of the active area of the display is maintained substantially constant for a series of consecutive UI images, irrespective of the content of the UI image.

15. The smart lens system of claim 14, wherein the smart lens system is caused to determine the pupil size by measuring illuminance, captured by at least one sensor, facing the pupil of the user of the smart lens.

16. The smart lens system of claim 15, wherein the smart lens system is caused to determine the pupil size of the user by measuring the illuminance at the pupil, using one of the sensor elements and measuring the illuminance at the iris, using another of the sensor elements.

17. The smart lens system of claim 15, wherein the at least one sensor is arranged in a first layer of the smart lens.

18. The smart lens system of claim 14, wherein the smart lens system is caused to adapt the size of the active area of the display by activating a certain number of pixels, distributed over the smart lens.

19. The smart lens system of claim 18, wherein the smart lens system is caused to activate the pixels in an area of the smart lens distributed substantially close to the boundary of the pupil.

20. The smart lens system of claim 14, wherein the smart lens system is caused to maintain the size of an active area of the display substantially constant for a series of consecutive UI images by maintaining certain number of pixels of the active area of the display active for a series of consecutive UI images.

21. The smart lens system of claim 14, wherein the smart lens system is further caused to adapt the content of the most recently acquired UI image in case it is determined that the light intensity of the active area of the display has reached a maximum value.

22. The smart lens system of claim 21 wherein the smart lens system is caused to adapt the most recently acquired UI image by executing at least one of:
removing content from the UI image by removing at least one specific object from the UI image;
removing content from the UI image by removing at least one part of the UI image, and
increasing the contrast between pixels of the UI image.

23. The smart lens system of claim 14, wherein the smart lens system is caused to control the total illuminance of the smart lens by dimming the lens, based on a determined change of the illuminance of the active area of the display between two consecutively acquired UI images.

24. The smart lens system of claim 14, wherein the smart lens system is caused to control the total illuminance of the smart lens by dimming the smart lens, based on a determined change of the ambient illuminance and the illuminance of the active area of the display between two consecutively acquired UI images.

25. The smart lens system of claim 24, wherein the smart lens system is caused to dim smart the lens by controlling a second layer of the smart lens.

26. The smart lens system of claim 14, wherein the smart lens system is caused to dim the smart lens based on at least one of:
content of at least one look up table, and
determination of the light intensity emitted from the active area of the display of the smart lens.

27. The smart lens system of claim 14, wherein the smart lens system is caused to determine the ambient illuminance by measuring the illuminance with at least one light sensor, arranged faced away from the pupil of the user of the smart lens system.

28. The smart lens system of claim 14, wherein the smart lens system is caused to reduce the light intensity emitted from the active area of the display, in case the dimming has reached a maximum level.

29. (canceled)
